(19) United States
(12) Patent Application Publication
(10) Pub. No.: US 2016/0328675 A1
(43) Pub. Date: Nov. 10, 2016

(54) MARKING METHODS FOR COMBATTING ILLICIT TRADE

(71) Applicant: CELANESE INTERNATIONAL CORPORATION, Irving, TX (US)

(72) Inventors: Paul BUSBY, Blacksburg, VA (US); Raymond M. ROBERTSON, Blackburg, VA (US); John L. PECKHAM, JR., Carrollton, TX (US)

(21) Appl. No.: 15/146,128

(22) Filed: May 4, 2016

Related U.S. Application Data
(60) Provisional application No. 62/157,265, filed on May 5, 2015.
(60) Provisional application No. 62/192,643, filed on Jul. 15, 2015.

(51) Int. Cl. G06Q 10/08; G06K 19/06

(52) U.S. Cl. CPC G06Q 10/087; G06K 19/06028

(57) ABSTRACT

Provided are tow bales, tow, and filaments containing an identifying marking thereon. The identifying marking provides origin information for the tow bale, tow, and/or filaments, to allow for tracing and tracking of the tow and filaments from point of manufacture to end product. The information may be used to combat illicit trade, particularly in textiles and tobacco products.

### CROSS-REFERENCE TO RELATED APPLICATIONS

This application claims priority to U.S. Provisional Application No. 62/157,265, filed on May 5, 2015, and to U.S. Provisional Application No. 62/192,643, filed on Jul. 15, 2015, the entireties of which are incorporated by reference herein.

### FIELD OF THE INVENTION

The present invention relates generally to marked articles, methods of marking the articles, and methods for tracking the articles from point of manufacture to purchaser. In particular, the present invention relates to marked tow, marked filaments formed into tow and marked additives incorporated into tow.

### BACKGROUND OF THE INVENTION

In the commercial manufacturing world, it is not uncommon for counterfeit goods to be manufactured, distributed, and sold in direct competition with authentic goods. Counterfeiting has reached epidemic proportions worldwide, especially in the area of consumer goods including goods made from fabric, plastic, leather, metal, or combinations thereof such as clothing, handbags and wallets, perfumes, and other consumer goods, including cigarettes.

It is common for the counterfeit articles to be of high quality and closely resemble authentic articles. Indeed, counterfeit articles can so closely resemble genuine goods that consumers readily confuse the counterfeit articles with the authentic articles. Thus, there exists a need for a marking method which enables a manufacturer to encode data represented by a mark or symbol, to direct marking of goods with the mark or symbol, and to enable remote inspection stations to check goods, whether articles of manufacture or basic material or financial instruments, for authentic marks or symbols and track authentic goods. Heretofore, such a comprehensive system was not available.

Additionally, problems encountered in the distribution of goods are not limited to the distribution of counterfeit goods. The clandestine or illegal diversion of the shipment and distribution of authentic goods presents a major problem in modern commerce. Goods manufactured at one location might be subject to controls, such as a tax, if distributed at a second location, but might not be subject to a tax if distributed at the location of manufacture or even at a third tax free location. Tobacco products, alcoholic beverages, drugs, and a wide variety of other goods and products fall into this category. Stated another way, authentic merchandise can become contraband if illegally distributed, diverted, pirated or “smuggled.” Diversion may include smuggling goods, unlicensed manufacture, internet trafficking, and shipment hijackings. Illicit trade, including the counterfeiting and diverting of goods, is costly to legitimate manufacturers as well as to tax authorities.

Textiles, especially high quality and high profile clothing, are susceptible to counterfeiting and diversion. Accordingly, several marking protocols have been proposed to combat counterfeit textile products. These marking protocols often include marked labels or other identifiers that indicate a genuine article. The diversion of textiles, however, has not been adequately addressed. Nor has there been a satisfactory marking method that allows for the determination of where the breakdown in the distribution chain occurred to allow for the diversion or counterfeiting of the textiles.

For example, U.S. Pat. No. 6,086,966 discloses a method for authenticating a textile product, wherein a colorless composition is applied to at least one portion of at least one thread of the textile product. The composition comprises one of a pair of a colorformer and an activator which react when mixed to produce a spectral response. The textile product is authenticated as genuine by applying the other of the pair of the colorformer and activator to at least one portion of the at least one thread to produce the spectral response. The textile product may be a thread or a woven label. This method, however, is predicated on authenticating genuineness for a particular product, and does not track and trace the textile from initial manufacture to point of sale.

U.S. Pat. No. 7,662,873 discloses preparing fibrous substrates, including textiles, marked with colloidal particle nanobar codes, as well as the fibrous substrates so prepared and methods for detecting the nanobar codes on the fibrous substrates for use in quality control, counterfeiting, and the like. The disclosure relies on NANOBARCODE™ particles added to the textile during the finishing step in textile manufacturing, as well as other marking methods. The markings, however, are used to authenticate genuineness but do not address where a breakdown in the distribution chain occurred.

Similarly, U.S. Publication No. 2002/0137417 discloses textile material for a garment which has microparticles bound in a binding agent in a demarcated area which will later face outwardly on the garment and can have, for example, the form of a registered trademark. The microparticles impart a changed appearance to the textile material in the demarcated area. The microparticles preferably contain fluorescent, phosphorescent, thermochomic or photochromic colorants. The purpose of the microparticles is to make imitation of the textile material more difficult. Again, the disclosure focuses on identifying a genuine article and does not teach markings that include origin information of the textile, which would allow for tracking and tracing of where in the distribution chain the diversion or counterfeiting occurred.

Tobacco products are also particularly susceptible to illicit trade, especially diversion. As of 2009, the World Health Organization Framework Convention on Tobacco Control estimated the worldwide tax loss to governments to be from $40 billion to $50 billion per year in unpaid excise taxes. In the United States, federal and state governments estimate that tobacco diversion costs over $5 billion per year in revenue from unpaid excise taxes. The Bureau of Alcohol, Tobacco, Firearms & Explosives has reported that cigarette diversion has been used to finance terrorist and organized crime activities. To date, however, tracking and tracing methods have been insufficient to substantially affect illicit trade. To combat counterfeiting, different carton, packaging or cigarette marking protocols have been implemented, but these protocols are a reactive solution instead of a proactive solution. Additionally, they only address counterfeit cigarettes, not the diversion of legitimate cigarettes. Diversion of cigarettes is prolific because of differing regional and international taxation regimes. For example, cigarettes might be taxable when sold in one state and not taxable or taxable at a lower tax rate when sold in another state. Current marking protocols have been unable to address the problem of cigarette diversion.

For example, U.S. Pat. No. 8,671,062 discloses the manufacture of goods marked or labeled with a secure unique identifier. A central checking center allows users to verify the authenticity of a particular good, such as a cigarette pack or carton via any convenient interface, such as the internet or a cell phone. The system of secret sharing allows secure authentication of each item and prevents code breaking or misuse. U.S. Publication Nos. 2014/0122353 and 2008/0046263 disclose similar marking or labeling methods. These methods, however, are unable to determine the source of the counterfeiting and are unable to detect diversion of legitimate goods.

U.S. Pat. No. 6,456,729 discloses a system and method of marking goods for authentication and tracking purposes using a central control. The system and method are accomplished in real time, affording manufacturers the ability to eliminate problems associated with counterfeiting and diversion which begin at one or more manufacturing sites which are remove from central control. A central control unit enables the system by providing an allotment of marks to one or more host units. Each host unit directs marking terminals to mark, at locations remote from the host units, particular goods or packages with specific information encoding symbols. Items are preferably marked directly with dyes containing one or more active compounds, but alternately can be identified by means of affixed fixtures which are marked with encoding symbols either prior to, or subsequent to, affixing to the items. Following marking, items are scanned to insure proper marking. Once within the commerce stream, items can be checked by illuminating the symbols marked thereon and cross referencing this data with the host database by using a field reading unit, or alternately decoded into clear text at the field reader for analysis. This method, however, requires a central control and is still directed to marking invoices or packaging. This method cannot be used to determine the source of the counterfeiting or diversion.

U.S. Pat. No. 8,584,435 discloses a conventional cigarette packet in a transparent film of bi-axially oriented polypropylene with a tear tape for removing the film adhered to the inside of the film. The tear tape bears an indicium which is either hidden or which changes according to the viewing angle when the image is viewed through the film. The image on the tear tape may be scrambled or coded. The overwrap film includes a descrambling or decoding region which reveals the hidden image or renders the image visible when viewed through the overwrap portion, or creates the visual effect of changing the image according to the viewing angle. The descrambling or decoding region typically comprises a diffraction structure, such as a grating, the characteristics of which, such as its pitch, are complementary with the scrambled or coded image and/or with the pitch of any grid or matrix from which the image is composed. As with other disclosed methods of marking, this method does not allow for cigarette component origin information to be determined, and thus the source of diversion of counterfeiting is unknown.

Accordingly, the need exists for a method of marking filaments, tow, and tow bales to allow for tracking and tracing of origin information for the filaments, tow and tow bales.

### SUMMARY OF THE INVENTION

In one embodiment, the present invention is directed to a tow bale, comprising compressed bands of crimped tow, wherein the tow includes repeated identifying markings thereon, and the identifying markings provide origin information concerning the tow. The origin information may comprise at least one of: (a) tow manufacturer; (b) tow manufacture date; (c) tow manufacture location; and/or (d) tow bale identifier. The repeated identifying markings may be etched, including laser etched, embossed, printed, including nanoprinted, stamped, and/or crimped on the tow. In some aspects, the repeated identifying markings may be disposed on individual tow filaments and/or may be disposed on an additive to the tow. The additive to the tow may be selected from the group consisting of: a filament, a multifilament, a fiber, a non-woven fabric, a woven fabric, a yarn, a staple fiber, a particle, and combinations thereof. The identifying marking may comprise a barcode, an image, a pattern, a number, a letter, or combination thereof. The tow may comprise filaments of at least one of a cellulose ester, polypropylene, polyester, polyethylene and viscose. In some aspects, the repeated identifying markings are contained in an additive to the tow. The additive to the tow may be selected from the group consisting of magnetic particles, paramagnetic particles, supermagnetic particles, and combinations thereof. The particles may be arranged in a pattern. In further aspects, the repeated identifying markings may be forensic markers, such as fluorescent forensic markers. The forensic markers may be sprayed onto the tow.

In another embodiment, the present invention is directed to tow comprising filaments of at least one of a cellulose ester, polypropylene, polyester, polyethylene and viscose, the tow having repeated identifying markings thereon, the identifying markings providing origin information concerning the tow. The origin information may comprise at least one of: (a) tow manufacturer; (b) tow manufacture date; (c) tow manufacture location; and/or (d) tow bale identifier. In some aspects, the repeated identifying markings may be disposed on individual tow filaments and/or may be disposed on an additive to the tow. The additive to the tow may be selected from the group consisting of: a filament, a multifilament, a fiber, a non-woven fabric, a woven fabric, a yarn, a staple fiber, a particle, and combinations thereof. The identifying marking may comprise a barcode, an image, a pattern, a number, a letter, or combination thereof. The repeated identifying markings may etched, including laser etched, embossed, printed, including nanoprinted, stamped, and/or crimped on the tow. The additive to the tow may be selected from the group consisting of: a filament, a multifilament, a fiber, a non-woven fabric, a woven fabric, a yarn, a staple fiber, a particle, and combinations thereof. In some aspects, the repeated identifying markings are contained in an additive to the tow. The additive to the tow may be selected from the group consisting of magnetic particles, paramagnetic particles, supermagnetic particles, and combinations thereof. The particles may be arranged in a pattern. In further aspects, the repeated identifying markings may be forensic markers, such as fluorescent forensic markers. The forensic markers may be sprayed onto the tow.

In yet another embodiment, the present invention is directed to a method of making tow having an identifying marking, the method comprising: (a) forming tow from filaments; (b) crimping the tow; (c) drying the tow; (d) baling the tow; and (e) marking the filaments and/or tow with an identifying marking during, between or after any of steps (a) to (d), wherein the identifying marking provides origin information concerning the tow. The origin information may comprise at least one of: (a) tow manufacturer; (b) tow manufacture date; (c) tow manufacture location; and/or (d) tow bale identifier. The tow may comprise filaments of at least one of a cellulose ester, polypropylene, polyester, polyethylene and viscose. The filaments may be marked with an identifying marking during step (a), after step (a) but prior to step (b), during step (b), after step (b) but prior to step (c), during step (c), and/or after step (c) but prior to step (d). Step (e) may comprise etching, including laser etching, embossing, printing, including nanoprinting, stamping, and/or crimping the identifying marking onto the tow. The identifying marking may comprise a barcode, an image, a pattern, and/or a number, a letter, or combination thereof. Step (e) may be performed continuously or discontinuously. When the marking is performed discontinuously, the tow may include an average longitudinally extending gap between identifying markings, the gap ranging from 0.5 μm to 5 mm. The identifying marking may be a repeated identifying marking. The method may further comprise: (f) blooming the tow to form bloomed tow; and (g) forming rods from the bloomed tow; wherein each rod includes the identifying mark on the bloomed tow contained therein. The identifying marking may be unique to the bale of tow. In some aspects, the identifying marking is visible to the human eye. In some aspects, the identifying marking is invisible to the human eye. In further aspects, the identifying marking may be visible through a microscope. The identifying marking may be read by a scanner. In some aspects, the identifying marking is contained in an additive to the tow or filaments. The additive to the tow or filaments may be selected from the group consisting of magnetic particles, paramagnetic particles, supermagnetic particles, and combinations thereof. The tow or filament by be marked by applying a magnetic field to the tow or filament to arrange the particles in a pattern. In further aspects, the identifying marking may be a forensic marker, such as a fluorescent forensic marker. The tow or filaments may be marked with the additive containing an identifying marking during step (a), after step (a) but prior to step (b), during step (b), after step (b) but before step (c), during step (c), and/or after step (c) but before step (d), by a method selected from the group consisting of dipping, immersing, submerging, soaking, rinsing, washing, painting, coating, showering, drizzling, spraying, placing, dusting, sprinkling, affixing, and combinations thereof.

In another embodiment, the present invention is directed to a method of making tow having an identifying marking, the method comprising: (a) forming tow from filaments; (b) crimping the tow; (c) drying the tow; (d) baling the tow; and (e) incorporating an additive with an identifying marking during, between or after any of steps (a) to (c), wherein the identifying marking provides origin information concerning the tow. The additive to the tow may be selected from the group consisting of: a filament, a multifilament, a fiber, a non-woven fabric, a woven fabric, a yarn, a staple fiber, a particle, and combinations thereof. The additive may be incorporated during step (a), after step (a) but prior to step (b), during step (b), after step (b) but before step (c), during step (c), and/or after step (c) but before step (d). The additive may be marked during incorporation during, between or after any of steps (a) to (c). In some aspects, the additive is marked prior to incorporation into the filaments or the tow. The identifying marking may be applied by etching, including laser etching, embossing, crimping, stamping and/or printing, including nanoprinting. The identifying marking may be a barcode, an image, a pattern, or a number, a letter, or combination thereof. In some aspects, step (e) comprises adding particles selected from the group consisting of magnetic particles, paramagnetic particles, supermagnetic particles, and combinations thereof to the additive and applying a magnetic field to the additive to arrange the particles in a pattern. In further aspects, step (e) comprises adding a forensic marker to the additive by a method selected from the group consisting of dipping, immersing, submerging, soaking, rinsing, washing, painting, coating, showering, drizzling, spraying, placing, dusting, sprinkling, affixing, and combinations thereof.

In yet another embodiment, the present invention is directed to a traceable textile comprising woven or non-woven fibers or filaments, the fibers or filaments having an identifying marking thereon, wherein the marking provides origin information concerning the fibers or filaments. The origin information may comprise at least one of: (a) fiber or filament manufacturer; (b) fiber or filament manufacture date; and/or (c) fiber or filament manufacture location; and/or (d) fiber or filament bale identifier. The identifying marking may be a repeated identifying marking. The identifying marking may be applied by etching, including laser etching, embossing, crimping, stamping and/or printing, including nanoprinting. The identifying marking may be a barcode, an image, a pattern, a number, a letter, or combination thereof. In some aspects, the identifying marking is contained in an additive to the fibers or filaments. The additive to the fibers or filaments may be selected from the group consisting of magnetic particles, paramagnetic particles, supermagnetic particles, and combinations thereof. The particles may be arranged in a pattern. In further aspects, the identifying marking may be a forensic marker, such as a fluorescent forensic marker. The forensic marker may be sprayed onto the fibers or filaments.

In another embodiment, the present invention is directed to a traceable textile comprising woven or non-woven fibers or filaments, the textile having an identifying marking thereon, wherein the marking provides origin information concerning the fibers or filaments. The origin information may comprise at least one of: (a) fiber or filament manufacturer; (b) fiber or filament manufacture date; (c) fiber or filament manufacture location; and/or (d) fiber or filament identifier. The identifying marking may be disposed on an additive to the textile. The additive to the textile may be selected from the group consisting of: a filament, a multifilament, a fiber, a non-woven fabric, a woven fabric, a yarn, a staple fiber, a particle, and combinations thereof. The identifying marking may be applied by etching, including laser etching, embossing, crimping, stamping and/or printing, including nanoprinting. The identifying marking may be a barcode, an image, a pattern, a number, a letter, or combination thereof. In some aspects, the identifying marking is contained in an additive to the textile. The additive to the textile may be selected from the group consisting of magnetic particles, paramagnetic particles, supermagnetic particles, and combinations thereof. The particles may be arranged in a pattern. In further aspects, the identifying marking may be a forensic marker, such as a fluorescent forensic marker. The forensic marker may be sprayed onto the textile.

In another embodiment, the present invention is directed to a traceable tow rod, comprising tow having an identifying marking thereon, the tow disposed in a wrapping material, the identifying marking providing origin information concerning the tow. The origin information may comprise at least one of: (a) tow manufacturer; (b) tow manufacture date; (c) tow manufacture location; and/or (d) tow identifier. The repeated identifying marking may be disposed on individual filaments and/or may be disposed on an additive to the tow. The additive to the tow may be selected from the group consisting of: a filament, a multifilament, a fiber, a non-woven fabric, a woven fabric, a yarn, a staple fiber, a particle, and combinations thereof. The identifying marking may be applied by etching, including laser etching, embossing, stamping, crimping and/or printing, including nanoprinting. The identifying marking may be a barcode, an image, a pattern, a number, a letter, or combination thereof. The tow may comprises filament of at least one of a cellulose ester, polypropylene, polyester, polyethylene and viscose. In some aspects, the identifying marking is contained in an additive to the tow. The additive to the tow may be selected from the group consisting of magnetic particles, paramagnetic particles, supermagnetic particles, and combinations thereof. The particles may be arranged in a pattern. In further aspects, the identifying marking may be a forensic marker, such as a fluorescent forensic marker. The forensic marker may be sprayed onto the tow.

In yet another embodiment, the present invention is directed to a traceable smokeable article, comprising a smokeable material and a filter, wherein the filter comprises a tow having an identifying marking thereon, the identifying marking providing origin information concerning the tow. The origin information may comprise at least one of: (a) tow manufacturer; (b) tow manufacture date; (c) tow manufacture location; and/or (d) tow identifier. The tow may comprise filaments of at least one of a cellulose ester, polypropylene, polyester, polyethylene and viscose. The identifying marking may be applied by etching, laser etching, embossing, stamping, crimping and/or printing, including nanoprinting. The identifying marking may be a barcode, an image, a pattern, a number, a letter, or combination thereof. In some aspects, the identifying marking is contained in an additive to the tow. The additive to the tow may be selected from the group consisting of magnetic particles, paramagnetic particles, supermagnetic particles, and combinations thereof. The particles may be arranged in a pattern. In further aspects, the identifying marking may be a forensic marker, such as a fluorescent forensic marker. The forensic marker may be sprayed onto the tow.

In another embodiment, the present invention is directed to a method of tracking cigarette filter tow, the method comprising the steps of: (a) forming the tow from filaments comprising at least one of a cellulose ester, polypropylene, polyester, polyethylene and viscose; (b) marking the filaments or the tow with a repeated identifying marking containing point of manufacture information; (c) providing the tow to a first purchaser; (d) forming the tow into a product; and (e) reading the identifying marking in the product to determine origin information of the tow. The origin information may comprise at least one of: (a) tow manufacturer; (b) tow manufacture date; (c) tow manufacture location; and/or (d) tow manufacture bale identifier. The identifying marking may be applied by etching, including laser etching, embossing, stamping, crimping and/or printing, including nanoprinting. The identifying marking may be a barcode, an image, a pattern, a number, a letter, or combination thereof. In some aspects, the repeated identifying markings are contained in an additive to the tow or filaments. The additive to the tow or filaments may be selected from the group consisting of magnetic particles, paramagnetic particles, supermagnetic particles, and combinations thereof. The tow or filaments be marked by applying a magnetic field to the tow or filaments to arrange the particles in a pattern. In further aspects, the repeated identifying markings may be forensic markers, such as fluorescent forensic markers. The tow or filaments may be marked with the additive containing an identifying marking during step (a), after step (a) but prior to step (b), during step (b), after step (b) but before step (c), during step (c), and/or after step (c) but before step (d), by a method selected from the group consisting of dipping, immersing, submerging, soaking, rinsing, washing, painting, coating, showering, drizzling, spraying, placing, dusting, sprinkling, affixing, and combinations thereof.

In yet another embodiment, the present invention is directed to a method of tracking cigarette filter tow, the method comprising the steps of: (a) forming the tow from filaments comprising at least one of a cellulose ester, polypropylene, polyester, polyethylene and viscose; (b) incorporating an additive comprising a repeated identifying marking containing point of manufacture information; (c) providing the tow to a first purchaser; (d) forming the tow into a product; and (e) reading the identifying marking in the product to determine origin information of the tow. The origin information may comprise at least one of: (a) tow manufacturer; (b) tow manufacture date; (c) tow manufacture location; and/or (d) tow manufacture bale identifier. The identifying marking may be applied by etching, including laser etching, embossing, stamping, crimping and/or printing, including nanoprinting. The identifying marking may be a barcode, an image, a pattern, a number, a letter, or combination thereof. In some aspects, step (b) may comprise adding particles selected from the group consisting of magnetic particles, paramagnetic particles, supermagnetic particles, and combinations thereof to the additive and applying a magnetic field to the additive to arrange the particles in a pattern. In other aspects, step (b) comprises adding a forensic marker to the additive by a method selected from the group consisting of dipping, immersing, submerging, soaking, rinsing, washing, painting, coating, showering, drizzling, spraying, placing, dusting, sprinkling, affixing, and combinations thereof.

In another embodiment, the present invention is directed to a method of detecting origin information of a rod comprising tow, wherein the tow includes a repeated identifying marking thereon, the method comprising the steps of: (a) dissecting the rod to expose the identifying marking, (b) reading the identifying marking, and (c) determining origin information from the identifying marking. The tow may comprise filaments comprising at least one of a cellulose ester, polypropylene, polyester, polyethylene and viscose. The identifying marking may be contained on the tow, on filaments formed into the tow and/or on an additive incorporated into the tow. The identifying marking may be applied by etching, laser etching, embossing, stamping and/or printing, including nanoprinting. The identifying marking may be a barcode, an image, a pattern, a number, a letter, or combination thereof. The repeated identifying marking may be contained in an additive to the tow. The additive may be selected from the group consisting of magnetic particles, paramagnetic particles, supermagnetic particles, and combinations thereof. The tow may be marked by applying a magnetic field to the tow to arrange the particles in a pattern. The repeated identifying marking may be a forensic marker, such as a fluorescent forensic marker. The tow may be marked with a repeated identifying marking with the additive by a method selected from the group consisting of dipping, immersing, submerging, soaking, rinsing, washing, painting, coating, showering, drizzling, spraying, placing, dusting, sprinkling, affixing, and combinations thereof. In other aspects, the tow may be marked with a repeated identifying marking by adding particles selected from the group consisting of magnetic particles, paramagnetic particles, supermagnetic particles, and combinations thereof to the additive and applying a magnetic field to the additive to arrange the particles in a pattern. In further aspects, the tow may be marked with a repeated identifying marking by adding a forensic marker to the tow by a method selected from the group consisting of dipping, immersing, submerging, soaking, rinsing, washing, painting, coating, showering, drizzling, spraying, placing, dusting, sprinkling, affixing, and combinations thereof.

### BRIEF DESCRIPTION OF THE DRAWING

The present invention will be better understood in view of the appended non-limiting figures, in which:

FIG. 1 is a schematic diagram of a tow process in accordance with an embodiment of the present invention;

FIG. 2 is a schematic diagram of another tow process in accordance with an embodiment of the present invention;

FIG. 3(a) is an illustration of a filament with a number marking in accordance with an embodiment of the present invention;

FIG. 3(b) is an illustration of a filament with a barcode marking in accordance with an embodiment of the present invention;

FIG. 3(c) is an illustration of a filament with an image marking in accordance with an embodiment of the present invention;

FIG. 4(a) is an illustration of tow with a number marking in accordance with an embodiment of the present invention;

FIG. 4(b) is an illustration of a tow with a barcode marking in accordance with an embodiment of the present invention;

FIG. 4(c) is an illustration of a tow with an image marking in accordance with an embodiment of the present invention;

FIG. 5(a) is an illustration of a cross-section of a dissected cigarette with a marking in accordance with an embodiment of the present invention;

FIG. 5(b) is an illustration of a cross-section of a cigarette filter with a barcode marking on a filament in accordance with an embodiment of the present invention;

FIG. 5(c) is an illustration of a cross-section of a cigarette filter with a barcode marking on the tow in accordance with an embodiment of the present invention; and

FIG. 5(d) is an illustration of a cross-section of a cigarette filter with a barcode marking on an additive in accordance with an embodiment of the present invention.

### DETAILED DESCRIPTION OF THE INVENTION

I. Introduction

The present invention relates generally to markings for filaments and/or tow that include origin information that may be used to track and trace the filaments and/or tow from point of manufacture to point of sale. The filaments and/or tow are marked prior to formation into end products, such as textiles or tobacco products, i.e., cigarette filters. The origin information contained in the marking may be used to determine where the breakdown in the distribution chain occurred. To date, methods for combatting counterfeiting have focused on using markings to indicate whether an article or good is genuine. While such markings do allow officials, such as law enforcement and customs officials, to seize counterfeit goods, a manufacturer is left with little recourse to combat the counterfeiting. With regard to diversion, seizure is again the remedy. While tax stamps on cigarette packaging may be used on a state by state or country by country basis, such stamps do not allow for tracking and tracing the origin information for the filament and/or tow to determine where the breakdown in the distribution chain occurred to prevent future diversion.

Embodiments of the present invention provide advantageous solutions to addressing counterfeiting and diversion of textiles and tobacco products. By providing a marking containing origin information on the filament and/or tow, prior to formation of the tow into an end product such as a textile or a cigarette filter, the breakdown in the distribution chain may be identified. Such information may then be used to prevent future counterfeiting and diversion. Thus, the present invention is related to marking, methods of marking, methods of tracking, and methods of detecting origin information.

In one embodiment, the present invention relates to a tow bale, comprising compressed bands of crimped tow, wherein the tow includes repeated identifying markings thereon. The identifying markings provide origin information concerning tow, including tow manufacturer, tow manufacture date, tow manufacture location, and/or tow manufacture bale identifier. The markings may be included on the tow itself, on individual filaments that are formed into the tow, or on an additive incorporated into the tow. The present invention is also related to methods of marking the tow bale, filaments, and additives during the tow bale formation.

In another embodiment, the present invention relates to a traceable tow rod comprising tow having an identifying marking thereon, the tow disposed in a wrapping material, such as a plugwrap. The identifying markings provide origin information concerning tow, including tow manufacturer, tow manufacture date, tow manufacture location, and/or tow inventory identifier. The markings may be included on the tow itself, on individual filaments that are formed into the tow, or on an additive incorporated into the tow.

In a further embodiment, the present invention relates to tow comprising filaments of at least one of a cellulose ester, polypropylene, polyester, polyethylene and viscose, the tow having repeated markings thereon. The identifying markings provide origin information concerning tow, including tow manufacturer, tow manufacture date, tow manufacture location, and/or tow inventory identifier. The markings may be included on the tow itself, on individual filaments that are formed into the tow, or on an additive incorporated into the tow. The present invention is also related to methods of marking the tow, filaments, and additives during tow formation.

The present invention also relates to a traceable smokeable article comprising a smokeable material and a filter, wherein the filter comprises a tow having an identifying marking thereon. The identifying markings provide origin information concerning tow, including tow manufacturer, tow manufacture date, tow manufacture location, and/or tow inventory identifier. The markings may be included on the tow itself, on individual filaments that are formed into the tow, or on an additive incorporated into the tow. The present invention is also related to methods of marking the tow, filaments, and additives during tow formation.

In another embodiment, the present invention relates to a method of tracking cigarette filter tow, the method comprising forming the tow and providing a marking providing origin information on the tow, the filaments forming the tow, or an additive incorporated into the tow. The tow is then provided to a first purchaser and then formed into a product. The identifying marking contained in the product is then read to determine the origin information of the tow.

In a further embodiment, the present invention relates to a method of detecting origin information of a rod comprising tow, wherein the tow includes a repeated identifying marking thereon. The method comprises dissecting the rod to expose the identifying marking, reading the identifying marking, and determining origin information from the identifying marking. The identifying marking provide origin information concerning tow, including tow manufacturer, tow manufacture date, tow manufacture location, and/or tow bale or inventory number.

In another embodiment, the present invention relates to traceable textiles comprising woven or non-woven fibers or filaments, the fibers or filaments having an identifying marking thereon. The identifying markings provide origin information concerning the fiber or filament, including manufacturer, manufacture date, manufacture location, and/or inventory number. The markings may be included on the textile itself, on individual filaments that are formed into the textile, or on an additive incorporated into the textile. The present invention is also related to methods of marking the textile, filaments, and additives during textile formation.

II. Markings

a. Types of Markings

Various markings may be used to provide origin information on the filaments, fibers, tow, tow bales, textiles and additives as described herein. The markings are included on the filaments, fibers, tow bales, textiles and additives so that each end product includes a marking. Thus, for a bale of tow, which may be used to form approximately six million cigarette filters, each cigarette filter would have a marking indicating origin information. Origin information is information that allows the filaments, fibers, tow and tow bales to be uniquely identifiable by at least one piece of information. This information may reflect the manufacturer, the date of manufacture, the manufacture location, an inventory or bale identifier, and combinations thereof. The marking may be a number, barcode, image, pattern, other inventory identifying marking, or combinations thereof. In some aspects, the marking may comprise at least two pieces of identifying information, at least three, or at least four. The identifying information may also be contained in combinations of markings.

When the marking is a number, a letter or a combination thereof, the marking may have a number from 1 to 15 digits, e.g., from 2 to 15 digits, or from 3 to 12 digits. The number may be used in combination with from 1 to 15 letters. For example, the number may reflect the date of manufacture and may be represented as 20150101, 150101, 01012015, 010115, or any variation thereof to indicate Jan. 1, 2015 as the date of manufacture. In further examples, a letter may be assigned to each year and month with a number assigned to each day. For example, if A is assigned to 2015 as the first digit, A is assigned to January, and numbers are used to indicate the day, Jan. 1, 2015 may be represented as AA1. Further detail may also be included in the number, such as manufacturer, manufacture location, and an inventory number. For example, if manufacturer, date of manufacture and inventory number for a tow bale were included, the marking could be a number and/or letter marking, for example CE for Celanese, AA1 for the date of manufacture, and A for the bale being the first bale of the day. Thus, the marking would be CEAA1A. Such a marking would be unique to this exact tow or bale. The marking would be recorded by the manufacturer, for example Celanese, in their inventory records. Thus, if a textile or smoking article were made from tow in the CEAA1A bale and the marking were read, the manufacturer would be able to provide origin information about the bale, including the identity of the first purchaser of the bale. By knowing the first purchaser, the breakdown in the distribution line that led to counterfeiting or diversion may be more easily identified. It is understood that when there is no intermediate distributor or other party involved in the supply line, the first purchaser may be the same purchaser formulating the end product.

In further aspects, the marking may be a random number, combination of letters, or may be alphanumeric. In this aspect, the random marking by itself does not impart origin information, but when compared to records, does provide origin information. For example, the identifier 1234567890 may be read on a cigarette filter. The number would be provided to the manufacturer, who would then consult records, such as inventory records, to determine the origin information of the filament, tow, and/or tow bale. As described above, the marking may comprise from 1 to 15 digits, from 1 to 15 letters, and combinations thereof. The complexity and length of the marking are not limited beyond the size of the printing and the balance of complexity of the marking with costs for marking the filament, tow and/or tow bale.

In cases where more than one tow or bale is to be provided to the same first purchaser, the marking need not be unique to each bale, but may be unique to the first purchaser, optionally in combination with the date of manufacture. For example, if the first purchaser is ABC corporation for the entire month of January, 2015, the inventory identifier could be ABC012015, A0115, or some variation thereof. A letter could also be assigned to each first purchaser in combination with other identifying information, such as the manufacturer, and date. Similar identifying codes could be used in textile production, with designations by designer, shipment site, country for shipment, and the like.

The number and/or letter marking may be read by a variety of methods, depending on the size of the marking. In some aspects, the marking may be read by the human eye. In other aspects, the marking is invisible to the human eye and may be read by a microscope or other activator, described herein.

When the marking is a barcode, a similar system may be used to determine how to provide a unique barcode marking by manufacturer, manufacture date, manufacture location, etc. The unique barcode should be readable with existing barcode readers. The barcode is a visual representation of data that is scanned and interpreted for information. The code included in the barcode works as a tracking technology and is represented in a sequence of lines or other shapes. Depending on whether the barcode is one dimensional or two dimensional, the barcode technology may be read by a standard barcode reader or newer technology, such as devices on smartphones and laptops. The barcode may be visible to the human eye, or may be invisible to the human eye and may be visible under a microscope or made visible by an activator.

When the marking is an image, the image may contain a symbol for the manufacturer in combination with other image data, including a color assigned to a specific month and/or date. Additionally, the image may be combined with other markings, including a number, barcode, or pattern. For example, the image may include a trademark of the manufacturer, while the color or an additional feature included in the image indicates a first purchaser, date of manufacture, or location of manufacture. The image may be visible to the human eye, or may be invisible to the human eye and may be visible under a microscope or made visible by an activator.

When the marking is a pattern, the pattern may be similar to a barcode in that it includes lines of varying thickness and size, but the pattern need not be read by a barcode reader. For example, the date of manufacture could be indicated by a month in the first two lines, a day in the second two lines, and a year in the last two lines, resulting in a six line pattern, with the lines having specified height, thickness or color. In another example, the first purchaser could be indicated by the pattern. The pattern need not be restricted to line format, so long as it provides origin information. The pattern may be visible to the human eye, or may be invisible to the human eye and may be visible under a microscope or made visible by an activator.

The sizing of the marking is dependent on the medium upon which the marking is applied. When the marking is applied to individual filaments, the size is adjusted so that the entire marking is visible on the filament. In some aspects, when the filament is a cellulose ester, such as cellulose acetate, the filament may have a denier per filament (dpf) from 1 to 15 and may have a diameter of a circular orifice from 20 to 80 micrometers, preferably from 30 to 70 micrometers. The length of the filament, may vary but when used in a cigarette filter, may range from 1 mm to 30 mm, e.g., from 5 to 30 mm. When used in textiles, the length of the filament in a non-woven textile (a staple fiber) may vary depending on the textile to be formed and the filament material. For example, some filaments may have a length from 5 to 30 mm, while others are much longer, ranging from 20 to 100 mm. Shorter lengths are also possible for nanofibers.

Because the markings are applied before a final product it formed, it is important that the markings remain legible and readable after the fiber, filament, additive, tow and/or tow bale has been formulated into a final product, such as a textile article or a cigarette filter. Various processing steps after the marking has occurred are described herein.

b. Methods of Marking

The marking is applied to the filament, fiber, tow, tow bale and/or additive by a physical marking method, including etching, embossing, printing, stamping, crimping, and combinations thereof. Each physical marking method is described in detail herein. Because the markings are intended to appear in each end product made from the filament, fiber or tow, it is important that each marking method is capable of high resolution and high speed marking that is permanent, e.g., will remain readable through processing of the filament, fiber or tow to the end product. It is also understood that combinations of marking methods may be used. For example, because crimping is a process step included in the tow process, crimping may be combined with etching, embossing, printing or stamping to form a crimped pattern unique to an end user and a number or letter identifier that is otherwise marked on the filament or tow which identifies origin information.

As described herein, the marking may be continuous or discontinuous, so long as the marking is spaced on the filament or tow so that each end product will contain the identifying marking. In some aspects, the average longitudinally extending gap between identifying markings may range from 0.5 μm to 5 mm; e.g., from 1 μm to 5 mm; from 5 μm to 5 mm.

The identifying marking may be a repeated identifying marking which appears at least twice on the discrete unit being marked. For example, a single tow bale may comprise the same identifying marking throughout the bale. The marking may be repeated in a manner sufficient to mark each end product. In a standard cellulose acetate tow bale, the marking may be repeated up to six million times. In some aspects, the discrete unit, such as the tow bale, may comprise more than one repeated identifying marking, such as two repeated identifying markings or three repeated identifying markings.

Etching

Etching as used herein refers to removing a layer of a surface of the filament or tow to leave a marking on the surface. The marking, as described herein, is selected so that it provides origin information for the filament or tow. Methods of chemically etching patterns onto fibers and textiles are disclosed in U.S. Pat. No. 4,466,860, and include treating an area of a fabric with a chemical composition that is reactive to certain parts of the fabric. The treated fabric is then heated to dry the chemical composition and to prevent distribution of the chemical into untreated fabric areas. Heat and pressure is then applied to the fabric to cause the chemical composition to react with and dissolve or otherwise destroy the fibers. After press-heating, the fabric may be washed to remove the dissolved fibers and chemical composition to produce the desired etched pattern. The chemical used for etching depends on the composition of the filament or fabric.

For example, a process for etching cellulose acetate fibers with a liquid or gas phase etchant has been disclosed in U.S. Pat. No. 7,878,210, the entirety of which is incorporated by reference herein. Although the etching disclosed in U.S. Pat. No. 7,878,210 is to create physical imperfections instead of to provide origin information for the filaments or tow, the overall process is still applicable.

The liquid phase etching may be carried out in the presence of hydrogen peroxide. The hydrogen peroxide may be an aqueous hydrogen peroxide solution with a concentration from 1 to 30 wt. %. Liquid etching methods include suspending the filaments in the hydrogen peroxide solution and then drying the fibers.

The gas phase etching may be carried out by exposing the cellulose acetate fibers to ozone, chlorine oxides, or nitrogen oxides, with ozone being preferred. Chlorine oxides include the compounds represented by the formula ClO, wherein x is 1 or 2, and y is an integer of from 1 to 7, such as ClO, ClO₂, ClO₃. Cl₂O, Cl₂O₂, Cl₂O₃. Cl₂O₄, Cl₂O₆ and Cl₂O₇, and is preferably ClO₂. Nitrogen oxides include the compounds represented by the formula N_{x′}O_{y′} wherein x′ is 1 or 2, and y′ is an integer of from 2 to 5, such as NO₂, N₂O₃, N₂O₄ and N₂O₅, and is preferably, NO₂. Gas phase etching methods may include continuously or discontinuously passing filaments and/or tow though a chamber and gradually replacing the air with the gas phase etchant.

Another method of etching includes using a laser to remove a layer of the filament or tow. Processes for marking materials with lasers are disclosed in U.S. Pat. No. 8,377,246, the entirety of which is incorporated by reference herein. Laser etching is a contact free process that allows for producing clean lines on a filament or tow. Laser etching systems include carbon dioxide systems, fiber systems, ultraviolet systems, and yttrium aluminum garnet (YAG) laser systems. Laser etching has high speed and resolution and may be especially advantageous for marking filaments and tow on a continuous or discontinuous basis.

The basic laser etching process comprises programming the identifying marking into the laser etching system and positioning the laser. The laser head may be positioned directly above the filament or tow, or may be positions at an angle to the filament or tow. The laser head may also be adjustable and may move during the etching process.

As described herein, the identifying marking may be applied to the filament or tow during various manufacturing steps in the tow process. It may, however, be particularly advantageous to etch or laser etch the filament or to etch the tow after it has been crimped. The location of etching may be determined by a variety of factors, including the physical setup of the tow process, i.e., physical distance and time between steps. For example, after crimping, the tow may be moved through the process at a slower speed than prior to crimping, allowing for etching at lower speed.

Embossing

Embossing refers to a process for creating a raised or recessed image in the filament or tow to provide a three-dimensional effect on selected areas of the filament or tow. Embossing relies on controlling pressure, heat, and die depth of the identifying marking to be embossed. A process for embossing fabrics containing cellulose acetate is disclosed in U.S. Pat. No. 1,889,045, the entirety of which is incorporated by reference herein. As taught in U.S. Pat. No. 1,889,045, embossing may be conducted with an aid, such as dilute acetone, to improve the permanence of the identifying marking. The pressure, heat and die depth are dependent on the properties of the filament or tow.

As described herein, the identifying marking may be applied to the filament or tow during various manufacturing steps in the tow process. It may, however, be particularly advantageous to emboss the tow prior to crimping because unlike etching, the embossing is mechanical and there are not as many physical restraints with regard to explosiveness in the earlier process steps as there may be with another marking method, such as etching. Embossing after crimping, however, is still advantageous because of the slower movement of the tow after crimping.

Printing

An identifying marking may be applied to the filament or tow by printing. Printing methods comprise affixing coloring, usually pigments, to the fabric, generally with the addition of a binder or adhesive. Printing methods include using silk screens, discharge printing, using wooden blocks, using stencils, or using a digital printing method, such as inkjet printing. Combinations of printing methods may also be used. Although any printing method may be used so long as the method is capable of printing fast enough to mark the filaments and tow so that the identifying marking appears on each end product made from the filament or tow, digital printing is the most preferred.

Digital printing is advantageous because it eliminates the set up expense associated with screen preparation and can allows cost-effective short run production. Inkjet printing furthermore allows visual effects such as tonal gradients and infinite pattern repeat sizes that cannot be practically achieved with a screen-printing process. The pigment is selected to that the ink penetrates the filament or tow but does not bleed through the filament or tow. The printing must also be configured to provide a readable identifying mark that is permanent and will not become distorted by downstream processing of the filament or tow. The size of the printing may vary depending on the size of the filament or tow to be marked, but may include nanoprinting.

In some aspects, the filament or tow is treated with a pre-treatment solution to improve the permanence of the printing, such as the solution described in U.S. Publication No. 2005/0193499.

As described herein, the identifying marking may be applied to the filament or tow during various manufacturing steps in the tow process. It may, however, be particularly advantageous to print the marking on the tow prior to crimping, for the reasons as described with regard to embossing. Printing after crimping, however, is still advantageous because of the slower movement of the tow after crimping.

Stamping

An additional method for marking the filament or tow with an identifying marking is to stamp the marking onto the filament or tow. The stamp is generally a dye containing pigments, that may be applied by a stamping cylinder, or other machinery that is capable of continuously or discontinuously applied a stamped identifying mark onto the filament or tow. The dye and pigments are selected to provide a permanent stamp that will still be readable in the end product, even after processing of the filament and tow. Additionally, depending on where the stamp is applied and what the end use of the product is, the dye and pigment should be capable of withstanding high temperatures, e.g., temperatures up to 250° C. In some aspects, the stamp is only applied to one side of the filament or tow, and thus is only readable from one side. In other aspects, the stamp is applied to both side of the filament or tow. An exemplary stamping method is disclosed in U.S. Pat. No. 4,238,524, the entirety of which is incorporated by reference herein.

As described herein, the identifying marking may be applied to the filament or tow during various manufacturing steps in the tow process. It may, however, be particularly advantageous to stamp the tow prior to crimping, for the reasons as described with regard to embossing. Stamping after crimping, however, is still advantageous because of the slower movement of the tow after crimping.

Crimping

Especially for synthetic filaments, it is desirable to crimp the filaments to increase the bulk of the filament, as well as other properties of the filaments. These other properties related to end uses of the filament or tow and include pressure drop, pressure drop variability, firmness, fly, and openability of the filament or tow. Crimping imparts a waviness to the filaments or tow. The amount of crimp is balanced with the difficulty associated with opening or blooming the tow for end use. For example, a tow with high crimp generally has higher fly (lint) and is more difficult to open than tow with lower crimp. However, high crimp improves pressure drop and pressure drop variability.

U.S. Pat. No. 7,585,441 discloses crimping processes for cellulose acetate tow. As described herein, crimp is imparted in a crimper with nip rollers. One or both of the nip rollers may be grooved to impart a pattern into the tow. When the crimping is used to impart a pattern onto the tow that provides origin information, the pattern imparted by the nip rollers is adjusted as needed. For example, if each bale will have unique origin information, the tow needed to form a bale will be marked with one pattern, and a new pattern would be set for tow needed to form another bale.

An advantage of using the crimper to impart a pattern onto the tow is that no extra equipment is introduced into the tow process. Instead, only the pattern on the nip roller(s) has to be adjusted.

III. Filament Formation and Tow

The present invention relates to filaments, fibers and tow formed therefrom. Generally, the invention is applicable to any type of filament or fiber that is formed into a tow and then processed into a textile or tobacco product. As used herein, filament refers to continuous fibers of natural or manmade origin and tow refers to an untwisted bundle of filaments. In some aspects, the filaments are selected from the group consisting of cellulose ester, polypropylene, polyester, polyethylene, viscose and combinations thereof. A description of the methods of forming each of the filaments is described below. A description of downstream processing, including forming the filaments into tow, and then forming the tow into end products, is also included.

Cellulose Ester Filament and Tow Formation

The cellulose ester flake may be prepared by known processes, including those disclosed in U.S. Pat. No. 2,740,775 and in U.S. Publication No. 2013/0096297, the entireties of which are incorporated by reference herein. The cellulose ester may be selected from the group consisting of cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethylcellulose acetate, carboxymethylcellulose acetate propionate, carboxymethylcellulose cellulose butyrate, cellulose acetate butyrate succinate, and mixtures thereof. In some aspects, the cellulose ester is cellulose acetate.

Typically, acetylated cellulose is prepared by reacting cellulose with an acetylating agent in the presence of a suitable acidic catalyst. Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high DS value along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction. When the cellulose acetate is intended for use in cigarette filters, the degree of substitution is less than 3.0, preferably from 2.2 to 2.8 or from 2.4 to 2.6.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Typically, most of these sulfate esters are cleaved during the controlled partial hydrolysis used to reduce the amount of acetyl substitution. Other acidic catalysts typically are much less likely to themselves react with the hydroxyl groups of cellulose.

One of the more highly desirable attributes of acetylated cellulose is that it can be readily processed into several different forms including, for example, films, flakes, fibers (e.g., fiber tows), non-deformable solids and the like depending on its intended end use application. Most often, the acetylated cellulose obtained from controlled partial hydrolysis precipitates as a flake material.

To form filaments from cellulose ester, a dope is formed by dissolving the cellulose ester dissolved in a solvent to form a dope solution. The solvent may be selected from the group consisting of water, acetone, methylethyl ketone, methylene chloride, dioxane, dimethyl formamide, methanol, ethanol, glacial acetic acid, supercritical carbon dioxide, any suitable solvent capable of dissolving the aforementioned polymers, and combinations thereof. In some aspects, the solvent is acetone or a combination of acetone and up to 5 wt. % water. Pigments may also be added to the dope. The dope may comprise from 20 to 30 wt. % cellulose acetate and from 70 to 80 wt. % solvent. Pigments, when added, may be present from 0.1 to 5 wt. %. The dope is then filtered and deaerated prior to being spun to form filaments. The dope may be spun in a spinner comprising one or more cabinets, each cabinet comprising a spinneret. The spinneret comprises holes that affect the rate at which the solvent evaporates from the filaments. The shape of the holes and spinning parameters may be selected to form filaments of a selected size, cross-sectional shape, strength and processability. Generally, the holes allow for filaments from 25 to 75 micrometers in diameter to be formed. Various designs for the holes are disclosed in U.S. Publication No. 2013/0192613, the entirety of which is incorporated herein.

The spinneret may be in a cabinet operated at a temperature up to 100° C. and the heat may be supplied by a hot air stream to evaporate the solvent. More than 90% of the solvent is evaporated during the spinning to leave solid filaments of cellulose acetate. The filaments generally range from 1 to 15 denier per filament and may have a cross-sectional shape including, but not limited to, circular, crenulated, Y, X, and dog bone. The strength of the filaments may be adjusted by modifying the temperature during spinning, as well as modifying the number of cabinets in the spinner. For example, when a filament first exists a spinneret, the filament may be easily damaged or broken. However, as the filament moves further from the spinneret, the filament hardens, increasing the strength of the filament and allowing for stronger and larger air flow to continue to evaporate the solvent. The flow of air through the spinner may be co-current or counter-current.

As the filaments exit the spinneret, they are fed onto a constant speed roll, where they may then be further stretched. Additional spinning techniques, including wet spinning and melt spinning may also be used in place of the dry spinning described herein. Optionally, a lubricant or finish may be added to the filament. Exemplary lubricants or finishes include mineral oil, emulsifiers, and water, as disclosed in U.S. Pat. No. 7,585,442, the entirety of which is incorporated by reference herein, although the lubricant or finish is not limited to these components. The lubricant or finish may be applied by spraying or wiping. Generally, the lubricant or finish is added to the filament prior to forming the filaments into tow.

The filaments are then bundled on a roller to form a tow. Generally, the tow may range from 10,000 to 100,000 total denier and may have a width (as measured from lateral edge to lateral edge), of less than 8 cm. Once the tow has been bundled, but prior to being crimped, the tow is plasticized. The plasticizer is generally sprayed onto the tow in liquid form, but other application method for the plasticizer may also be used. The plasticizer is selected to act as a binder or hardener of the cellulose acetate. Numerous types of plasticizers may be used in amounts from 2 to 40 wt. %. The amount of plasticizer used depends on the plasticizer itself, as well as the desired hardness of the plasticized tow.

In some preferred embodiments, the plasticizer is water, although numerous other plasticizers may also be utilized. Plasticizers suitable for use in conjunction with a plasticized cellulose ester described herein may, in some embodiments, include, but are not limited to,

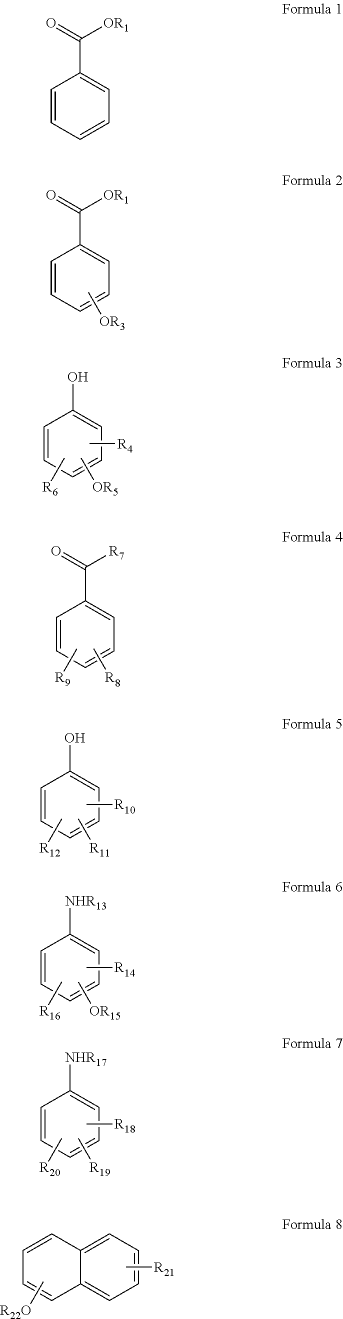

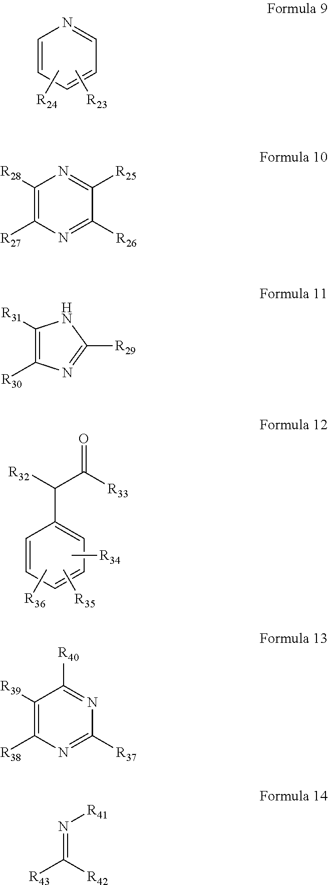

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with a plasticized cellulose ester described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol tribenzoate, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Additional examples of plasticizers suitable for use in conjunction with a plasticized cellulose ester described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose esters, alone or in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional cellulose ester plasticizers like triacetin, has been observed to plasticize cellulose ester.

In some embodiments, the plasticizers may be food-grade plasticizers, which may be useful in producing a plasticized cellulose ester described herein for use in applications where the cellulose ester plastics may directly or indirectly contact food (e.g., food containers). Examples of food-grade plasticizers may, in some embodiments, include, but are not limited to, triacetin, diacetin, tripropionin, tribenzoin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, glycerol tribenzoate, polyethoxylated fatty alcohols, and the like, and any combination thereof.

In some embodiments, the plasticizers may be bio-derived, which may be useful in producing cellulose ester plastics that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some embodiments, cellulose esters of a plasticized cellulose ester described herein may have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination.

In some embodiments, cellulose esters of a plasticized cellulose ester described herein may have a degree of substitution of the ester substituent ranging from a lower limit of about 0.5, 1.2, or 2 to an upper limit of less than about 3, about 2.9, 2.7, or 2.5, and wherein the degree of substitution may range from any lower limit to any upper limit and encompass any subset therebetween.

In some embodiments, cellulose esters of a plasticized cellulose ester described herein may have a molecular weight ranging from a lower limit of about 10,000, 15,000, 25,000, 50,000, or 85,000 to an upper limit of about 300,000, 200,000, 150,000, 125,000, 100,000, or 85,000, and wherein the molecular weight may range from any lower limit to any upper limit and encompass any subset therebetween. As used herein, the term “molecular weight” refers to a polystyrene equivalent number average molecular weight (Mₙ).

In some embodiments, cellulose esters of a plasticized cellulose ester described herein may have an intrinsic viscosity ranging from a lower limit of about 0.5 dL/g, 0.7 dL/g, or 1.0 dL/g to an upper limit of about 2.0 dL/g, 1.7 dL/g, 1.5 dL/g, or 1.3 dL/g, and wherein the intrinsic viscosity may range from any lower limit to any upper limit and encompass any subset therebetween. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{rel} ) / k ) - 1 ) \\ where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

In some aspects, two or more plasticizers may be used. Additionally, a thermoplastic polymer may also be included with the tow during the plasticizing step. Thermoplastic polmers include polyolefins (e.g., polyethylene and polypropylene), polyalphaolefins, polyesters, ethylene vinyl acetate copolymers, polyvinyl acetate, polyvinyl alcohol (“PVOH”), a polyethyleneimine, polyacrylates, polymethacrylates, polyacrylamides, polyacrylonitriles, polyimides, polyamides, polyvinyl chloride, polysiloxanes, polyurethanes, polystyrene, polyetheramide copolymers, styrene-butadiene copolymers, styrene-butadiene-styrene copolymers, styrene-isoprene-styrene copolymers, styrene-ethylene-butylene-styrene copolymers, styrene-ethylene-propylene-styrene copolymers, butyl rubber, polyisobutylene, isobutylene-isoprene copolymers, acrylics, nitriles, and combinations thereof.

Once the tow has been plasticized, it is directed to a crimper. In some aspects, the tow is plasticized at least 0.5 meters before entering the crimper, e.g., at least 1 meter before. While numerous crimpers are known in the art, they generally operate by drawing the tow into a crimper, where rollers having some type of groove or surface texturing induce crimp into the tow. As described in U.S. Pat. No. 7,585,442, the entirety of which is incorporated by reference herein, the crimper may be a stuffer box crimper having a base frame and a top frame that moves in relation to the base frame. The crimper comprises nip rollers, cheek plates on the lateral edges of the nip rollers, doctor blades, a flapper, and a steam injector.

The tow is pulled through the crimper by a pair of nip rollers which may be referred to as “induced crimp” rollers because they crease or bend the tow is it passes through the nip, thus influencing the location of crimp in the tow. Of the pair of nip rollers, one nip roller may be smooth while another nip roller may be grooved. The grooves may be of any type that include a surface texture, such as grooves, dimples, or other types of texturing. The grooves are preferably in the form of a sine curve, but may also be rectangular, triangular, or semicircular notches, grooves, or ridges with or without flat surfaces therebetween that extend axially (i.e., lateral to lateral) across the face of the roller. These grooves may range from 10 to 100 grooves per inch (2.5 cm), preferably 25 to 75 grooves per inch (2.5 cm), most preferably 50 grooves per inch (2.5 cm). The groove depth (peak to trough) may range from 0.5 mils to 5.0 mils (12.5 micron to 150 microns), preferably 1-2 mils (25-50 microns).

Each of the nip rollers may be made of a metallic or ceramic material, including but not limited to steel/alloy bonded titanium carbides, tungsten carbides, hipped or unhipped MgO stabilized zirconia, or hipped or unhipped yttria stabilized zirconia. In some embodiments, an upper nip roller is smooth while a lower nip roller is grooved. The tow leaves the nip rollers and enters the stuffer box. In some aspects, the edges of the tow may be lubricated prior to entry into the stuffer box to minimize filament damage between the nip rollers and cheek plates that are located on the lateral sides of the nip rollers. These cheek plates may serve as guides to keep the tow between the nip rollers. The doctor blades are located next to the nip rollers are function to direct the tow into the stuffer box and to keep the tow from sticking to the rollers.

The stuffer box comprises a steam injector in each half of the stuffer box, placed adjacent to the nip rollers. The steam injector injects steam, generally low-pressure dry steam at a temperature of about 100° C., into the stuffer box to set and lightly bond the crimp of the tow in the channel of the stuffer box.

The configuration of the crimp may play a role in the processability of the final bale. Examples of crimp configurations may include, but not be limited to, lateral, substantially lateral, vertical, substantially vertical, some degree between lateral and vertical, random, or any combination thereof. It should be noted that the terms lateral and vertical refer to general overall crimp orientation and may have deviation from said configuration by +/−about 30 degrees.

The configuration of the crimp may also be important for the processability of the final bale in subsequent processing steps, e.g., a lateral and/or substantially lateral crimp configuration may provide better cohesion of filaments than a vertical and/or substantially vertical crimp configuration unless further steps are taken to enhance cohesion. To achieve a lateral crimp, at least one of three processing parameters may be manipulated, e.g., the water content of the tow prior to crimping, the thickness of the tow during crimping, and the nip to flap force ratio during crimping.

To achieve a lateral and/or substantially lateral crimp configuration, it may be desirable to perform crimping on a tow comprising filaments having a lower weight percentage of total moisture, such as from 5 to 25%, e.g. In some embodiments a lower weight percentage of moisture may be achieved by drying the tow prior to crimping, applying a higher solids concentration or finish emulsion with less water content, applying a neat finish followed by separate control water addition, reducing or eliminating any other moisture contributing tow additions, altering the spinning conditions so as to reduce the moisture content of the fiber leaving the spinning cell (higher temp, slower speed, higher air flow in heating cabinet, change concentration of dope), or any combination thereof.

Further, a lateral and/or substantially lateral crimp configuration may be achieved by crimping a thinner tow, i.e., reducing the total denier per inch of crimper nip roller width. In some embodiments, total denier per inch of crimper nip roller width may be about 60,000 or less, about 50,000 or less, or about 40,000 or less. Suitable total denier per inch of crimper nip roller width may range from a lower limit of about 5,000, 10,000, 15,000, or 20,000 to an upper limit of 60,000, 50,000, 40,000, 35,000, or 30,000 and wherein the total denier per inch of crimper nip roller width may range from any lower limit to any upper limit and encompass any subset therebetween.

Further, a lateral and/or substantially lateral crimp configuration may be achieved by crimping with a reduced nip to flap force ratio, i.e., the ratio of applied nip force to applied flap force. In some embodiments, the nip to flap force ratio may be about 100:1 or less, about 50:1 or less, or about 25:1 or less. Suitable nip to flap force ratios may range from a lower limit of about 3:1, 5:1, or 10:1 to an upper limit of about 100:1, 50:1, or 25:1, and wherein the nip to flap ratio may range from any lower limit to any upper limit and encompass any subset therebetween.

It should be noted that at least two of the foregoing methods of achieving a lateral and/or substantially lateral crimp configuration may be used in any combination. It should also be noted that when used in combination the aforementioned parameter limitations may be expanded as the combination may have synergistic effects. By way of nonlimiting example, a tow with about 27% moisture w/w of tow that undergoes crimping at a nip to flap force ratio of about 15:1 with a total denier per inch of crimper nip roll width of about 25,000 may yield a lateral and/or substantially lateral crimp configuration.

Once crimped, the tow may be directed to a dryer for drying and removal of residual water and/or acetone. The dried tow is then fed into a can to form a towlayer. The dried tow may be placed in the can by a series of rollers, e.g., by laying, depositing, or arranging, the tow in a can in a pattern. It should be noted that can is used generically to refer to a container that may be in any shape, preferably square or rectangle, and of any material. The term “pattern” refers to any design which may or may not change during placing. In some embodiments, the pattern may be substantially zig-zag having a periodicity of about 0.5 cycles/ft to about 6 cycles/ft. In some embodiments, placing may involve puddling the tow with a puddling index of about 10 m/m to about 40 m/m. The term “puddling” refers to allowing the tow to lay at least partially on itself so as to place a greater actual length of tow than linear distance on which it is placed. The term “puddling index” refers to the length of tow per linear distance on which it is placed.

The towlayer is then moved to a bale press, there the bale is compressed and packaged for shipment. The can is set in the press walls and is then compressed by platens. Exemplary tow bale compression and bale press designs are disclosed in U.S. Pat. No. 7,610,852, the entirety of which is incorporated by reference herein. Generally, the bale press comprises two shaped platens which are selected to allow for the formation of tow with a substantially flat surface which is maintained through packaging. Such a substantially flat surface is advantageous because it allows for stacking of the bales during storage and shipment. Additionally, a flat surface on the bale is advantageous during the de-baling process, described herein, because the tow is less likely to become entangles and the de-baling may be accomplished more efficiently.

In some embodiments, the packaging may include at least one component like wrapping materials, vacuum ports (for releasing and/or pulling vacuum), securing elements, or any combination thereof. Suitable wrapping materials may include, but not be limited to, air-permeable materials, air-impermeable materials, films (e.g., polymeric films, polyethylene films, plastic wrap), heat-shrinkable films, cardboard, wood, woven materials (i.e., fabric composed of two sets of yarns interlaced with each other to form the fabric), non-woven materials (i.e., assemblies of textile fibers held together by mechanical or chemical means in a random web or mat, e.g., fused thermoplastic fibers), foil materials (e.g., metallic materials), and the like, or any combination thereof. Suitable securing elements may include, but not be limited to, VELCRO®, pins, hooks, straps (e.g., woven, non-woven, fabric, and/or metallic), adhesives, tapes, melt bondings, and the like, or any combination thereof. In some embodiments, at least a portion of the packaging (including any component thereof) may be reusable.

In some embodiments, bales may have dimensions ranging from about 30 inches (76 cm) to about 60 inches (152 cm) in height, about 46 inches (117 cm) to about 56 inches (142 cm) in length, and about 35 inches (89 cm) to about 45 inches (114 cm) in width. In some embodiments, bales may range in weight from 900 pounds (408 kg) to 2100 pounds (953 kg). In some embodiments, bales may have a density greater than about 300 kg/m³ (18.8 lb/ft³).

Polypropylene Filament and Tow Formation

Polypropylene is a thermoplastic polymer resin used in a variety of products, including in the textile industry and in the tobacco industry. Polypropylene is used in cigarette filters as a staple fiber and is also used in textiles in a wide range of areas, including clothing, furniture fabrics, luggage, and household textiles such as table cloths. Polypropylene is also used in medical settings to form disposable fabrics, including face masks. Polypropylene is recyclable, resistant to fatigue, and relatively easy to tail grade of polypropylene to specific molecular weights.

Polypropylene is manufactured by one of three basic methods: 1) a hydrocarbon slurry or suspension, 2) a bulk slurry, or 3) gas phase. The first method, the hydrocarbon slurry or suspension, uses a liquid inert hydrocarbon diluent in a reactor to facilitate transfer of propylene to a catalyst, the removal of heat from the system, and the deactivation and removal of the catalyst. The liquid inert hydrocarbon diluent also serves to dissolve the polymer. A more common method is the bulk slurry method, which uses liquid propylene instead of a liquid inert hydrocarbon diluent. The formed polymer is withdrawn from the reactor and any unreacted monomer is flashed off. The gas phase method uses gaseous propylene in contact with a solid catalyst, resulting in a fluidized bed medium.

The polypropylene formed by any of the above methods may then be melt processed via extrusion and molding to form melt-blown and spun-bonded fibers. Extrusion may generally be conducted at a temperature from 195 to 260° C., with temperatures near the upper end of this range used for forming fibers. The extrusion may be through spinneret holes as described herein in reference to cellulose esters. Additional processing steps to form tow from polypropylene are similar to those described herein in reference to cellulose esters. A process specific to forming polypropylene tow is described in U.S. Pat. No. 3,595,245, the entirety of which is incorporated by reference herein.

Polyester Filament Formation

Polyesters are a broad class of polymer that are used in a wide range of textile and tobacco products. In textiles, the most commonly used polyester is polyethylene terephthalate (PET). In tobacco products, degradable polyesters are used, including polyglycolic acid, polylactic acid, polyhydroxyalkanoates, polycaprolactone, polybutylene succinic adipate, and copolymers or blends thereof. Generally, polyesters are formed by condensation polymerization of an acid and alcohol reacted in a vacuum at high temperature. The polymer is extruded in the form of a ribbon onto a cooling wheel and then, after the ribbon hardens, the polymer is cut into chips. The chips are dried and may then be melt spun to form a filament.

The polyester filament may be formed on a continuous spin-draw system, which allows for feeding the filaments over heated rolls at temperatures ranging from 75 to 130° C. A lubricant or finish may be applied to the filaments during the drawing steps.

An exemplary process for producing polyester filament tow is disclosed in U.S. Pat. Nos. 3,715,412 and 6,706,393, the entireties of which are incorporated herein. The filament may then be crimped, dried and baled as described in references to the cellulose esters.

Polyethylene Filament and Tow Formation

Polyethylene is formed by polymerizing ethylene, generally using a Ziegler-Natta catalyst, formed from titanium (III) chloride, or a Phillips catalyst, formed by depositing chromium (VI) oxide on silica. Polyethylene is classified by its density and branching, and includes ultra-high-molecular-weight polyethylene, ultra-low-molecular-weight polyethylene, high-molecular-weight polyethylene, high-density polyethylene, high-density cross-linked polyethylene, cross-linked polyethylene, medium-density polyethylene, linear low-density polyethylene, very-low-density polyethylene, and chlorinated polyethylene. Once the polyethylene polymer is formed, it may be melt spun to form a filament, generally at a temperature from 50 to 150° C. The filament may have a weight-average molecular weight of 300,000 or less, and a ratio of a weight-average molecular weight to number-average molecular weight of 4.0 or less. While filaments with greater weight-average molecular weights may be used, the melt viscosity is very high and melt molding becomes difficult. Polyethylene may be used in textiles as well as in tobacco products.

Once spun, the polyethylene filament is quenched with cool air and drawn at a predetermined speed. In some aspects, the ratio of the velocity of the fluid product in the spinner and the spinning speed is at least 100, at least 150, or at least 200. Once the polyethylene filament is formed, the filament may then be crimped, dried and baled as described in reference to the cellulose esters.

Viscose Filament and Tow Formation

Viscose, formerly referred to as viscose rayon or as rayon, is a fiber of regenerated cellulose that is structurally similar to cotton. Viscose may be used in textiles, as well as in tobacco products. The first viscose was produced from the reaction product of carbon disulfide and cellulose under basic conditions. The process to form viscose includes the following steps: impregnating cellulose with concentrated aqueous sodium hydroxide to form alkali cellulose, squeezing out the excess caustic soda solution, shredding the press cake shredded, aging the crumbs (to degrade the cellulose) under controlled conditions (time, temperature, minimum exposure to carbon dioxide, oxygen, etc.) to provide for proper viscose viscosity, treating the aged crumbs with carbon bisulfide to produce sodium cellulose xanthate (a lumpy orange-colored product varying from a mealy to a sticky consistency), dissolving or dispersing the xanthate in dilute aqueous caustic alkali, filtering the solution or dispersion, and ripening the resultant viscose until suitable for extrusion and regeneration into filaments.

To form viscose filaments, a viscose solution is continuously extruded through a spinner, along with a coagulating solution. The coagulating solution may have a constant temperature from 30 to 65° C. The filaments are drawn through the spinner and washed under tension to increase the length of the filaments. The length of the filaments may also be varied by modifying the flow rate of the coagulating solution. The filaments are then finished, dried, and packaged. The filaments may also be crimped, dried and baled as described in reference to the cellulose esters.

IV. Additives

As described herein, the tow or textile may be comprised of filaments and may also contain an additive. The additive may include, but is not limited to a filament, a multifilament, a fiber, a non-woven fabric, a woven fabric, a yarn, a staple fiber, a particle, and combinations thereof. So long as the additive is capable of being marked as described herein and is compatible with the contemplated end use of the textile or tow, it may be included as an additive. In some aspects, the additive may be the same filament or filaments that are the main component of the tow or textile, but may be incorporated into the tow or textile separately. In other aspects, the additive is different than the main component of the tow or textile. The additive may be present in the tow or textile in small amounts on a percentage of total denier basis, e.g., up to 5%, up to 3%, up to 1%, or up to 0.1%. In terms of ranges, the additive may be present from 0.01 to 5% of the total denier of the tow, e.g., from 0.01 to 3%, from 0.01 to 1% or from 0.01 to 0.1%.

The filaments or tow may also comprise conventional additives, including, but not limited to, active particles, active compounds, ion exchange resins, zeolites, nanoparticles, ceramic particles, rare earth metals and compounds thereof (including scandium, yttrium, lanthanum, cerium, praseodymium, neodymium, promethium, samarium, europium, gadolinium, terbium, dysprosium, holmium, erbium, thulium, ytterbium, and lutetium), softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, antistatic agents, flame retardants, antifoaming agents, degradation agents, conductivity modifying agents, stabilizing agents, or any combination thereof. In some aspects, these additives may be added to the polymer during spinning and may be used as a marking to indicate origin information. For example, a specific pigment or dye could be incorporated for different distributors. The conventional additives may range in particle size, depending on when they are included in the filament. For example, if the conventional additive is added to the dope, the particle size may range from 0.01 to 1000 microns, e.g., from 0.1 to 100 microns, or from 0.1 to 10 microns.

In some embodiments, achieving filaments that comprise an additive may be by including the additives in the dope, combining additives and then adding the combination to the dope; by applying the additives to the filaments before, after, and/or during formation of tow; by applying the additives to the filaments before, after, and/or during crimping tow; by applying the additives to the filaments before, after, and/or during conditioning the crimped tow band; and any combination thereof. It should be noted that applying includes, but is not limited to, dipping, immersing, submerging, soaking, rinsing, washing, painting, coating, showering, drizzling, spraying, placing, dusting, sprinkling, affixing, and any combination thereof. Further, it should be noted that applying includes, but is not limited to, surface treatments, infusion treatments where the additive incorporates at least partially into the filament, and any combination thereof.

Suitable active particles may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, an alumina nanoparticle, a magnetic nanoparticle, paramagnetic nanoparticle, a superparamagnetic nanoparticle, a gadolinium oxide nanoparticle, a hematite nanoparticle, a magnetite nanoparticle, a gado-nanotube, an endofullerene, Gd@C₆₀, a core-shell nanoparticle, an unionated nanoparticle, a nanoshell, an unionated iron oxide nanoparticle, activated carbon, an ion exchange resin, a desiccant, a silicate, a molecular sieve, a silica gel, activated alumina, a zeolite, perlite, sepiolite, Fuller's Earth, magnesium silicate, a metal oxide, iron oxide, activated carbon, and any combination thereof.

Suitable active particles may have at least one dimension of about less than one nanometer, such as graphene, to as large as a particle having a diameter of about 5000 microns. Active particles may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in the present invention, wherein the selected maximum size is greater than the selected minimum size. In some embodiments, the active particles may be a mixture of particle sizes ranging from the above lower and upper limits. In some embodiments, the size of the active particles may be polymodal.

Suitable active compounds may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, and any combination thereof.

Suitable ion exchange resins may include, but not be limited to, polymers with a backbone, such as styrene-divinyl benezene (DVB) copolymer, acrylates, methacrylates, phenol formaldehyde condensates, and epichlorohydrin amine condensates; a plurality of electrically charged functional groups attached to the polymer backbone; and any combination thereof.

Zeolites may include crystalline aluminosilicates having pores, e.g., channels, or cavities of uniform, molecular-sized dimensions. Zeolites may include natural and synthetic materials. Suitable zeolites may include, but not be limited to, zeolite BETA (Na₇(Al₇Si₅₇O₁₂₈) tetragonal), zeolite ZSM-5 (Naₙ(AlₙSi₉₆₋ₙO₁₉₂) 16H₂O, with n<27), zeolite A, zeolite X, zeolite Y, zeolite K-G, zeolite ZK-5, zeolite ZK-4, mesoporous silicates, SBA-15, MCM-41, MCM48 modified by 3-aminopropylsilyl groups, alumino-phosphates, mesoporous aluminosilicates, other related porous materials (e.g., such as mixed oxide gels), or any combination thereof.

Suitable nanoparticles may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagnetic nanoparticles like gadolinium oxide, various crystal structures of iron oxide like hematite and magnetite, about 12 nm Fe₃O₄, gado-nanotubes, and endofullerenes like Gd@C₆₀; and core-shell and unionated nanoparticles like gold and silver nanoshells, unionated iron oxide, and others nanoparticles or microparticles with an outer shell of any of said materials; or any combination of the foregoing (including activated carbon). It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or 30), amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetraacetate, diethylenetriaminepentaacetic acid, triglycollamic acid, and a structure comprising a pyrrole ring; and any combination thereof. Functional groups may enhance removal of smoke components and/or enhance incorporation of nanoparticles into a porous mass.

Suitable softening agents and/or plasticizers may include, but not be limited to, water, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof. One skilled in the art with the benefit of this disclosure should understand the concentration of plasticizers to use as an additive to the filaments. By way of non-limiting example, the plasticizer may be added to the dope in an amount sufficient to prevent rupture or bursting of the filament surface upon sudden thermal discharge of the adsorbed solvent.

As used herein, pigments refer to compounds and/or particles that impart color and are incorporated throughout the filaments. Suitable pigments may include, but not be limited to, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, or any combination thereof.

As used herein, dyes refer to compounds and/or particles that impart color and are a surface treatment of the filaments. Suitable dyes may include, but not be limited to, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L).

Suitable flavorants may be any flavorant suitable for use in smoking device filters including those that impart a taste and/or a flavor to the smoke stream. Suitable flavorants may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein. These flavorants may be placed in the tobacco column or in a section of a filter. Additionally, in some embodiments, the porous masses of the present invention may comprise a flavorant. The amount to include will depend on the desired level of flavor in the smoke taking into account all filter sections, the length of the smoking device, the type of smoking device, the diameter of the smoking device, as well as other factors known to those of skill in the art.

Suitable aromas may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers may include, but not be limited to, methylcellulose, ethylcellulose, hydroxyethylcellulose, carboxy methylcellulose, carboxy ethylcellulose, water soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl)acrylamide, methacrylamides, hydroxy alkyl (meth)acrylates, methacrylic acids, acrylic acids, hydroxyethyl acrylates, and the like, any derivative thereof, or any combination thereof.

Suitable lubricating agents may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from non-water soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers may include, but not be limited to, sorbitan monolaurate, e.g., SPAN® 20 (available from Uniqema, Wilmington, Del.), poly(ethylene oxide) sorbitan monolaurate, e.g., TWEEN® 20 (available from Uniqema, Wilmington, Del.).

Suitable vitamins may include, but not be limited to, vitamin A, vitamin B1, vitamin B2, vitamin C, vitamin D, vitamin E, or any combination thereof.

Suitable antimicrobials may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexamethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof. Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective antistats.

As described herein, additives may be used to mark the filaments and/or tow with origin information. In some aspects, magnetic particles may be included as an additive and may be used as a marking to indicate origin information. Such magnetic particles include magnetic nanoparticles, paramagnetic nanoparticles and/or superparamagnetic nanoparticles, though the magnetic particles are not limited to nanoparticles. The magnetic particles may be added as a solid, semi-solid or as a liquid (in solution, a dispersion, or an emulsion). The magnetic particles may be formed into a pattern and the pattern may be used to indicate origin information. This pattern may operate similarly to a barcode, containing unique information that corresponds to origin information. The pattern may be formed by applying a magnetic field to the particles with a magnet. The magnetic particles may be included with the dope, by applying the additives to the filaments before, after, and/or during formation of tow; by applying the additives to the filaments before, after, and/or during crimping tow; by applying the additives to the filaments before, after, and/or during conditioning the crimped tow band; and any combination thereof. The orientation of the magnetic particles with a magnet to form a pattern may also occur at various points in the manufacturing process, including forming a pattern on the filament before, after, and/or during formation of tow; by forming a pattern on the filament before, after, and/or during crimping tow; by forming a pattern on the filament before, after, and/or during conditioning the crimped tow band; and any combination thereof.

In further aspects, the additive's presence in and of itself is sufficient to mark the filament and/or tow with origin information. For example, dyes and pigments may be included to mark the filament and/or tow with origin information. Although the presence of a dye or pigment may, in and of itself be sufficient to identify origin information, specific dyes or pigments that fluoresce under ultraviolet light may be preferred because they are not ordinarily visible the human eye. By using fluorescent dyes or pigments, the dye or pigment would not be visible except under ultraviolet light. Similar marking systems have been described in different fields, including in U.S. Pub. No. 2013/0110684, the entirety of which is incorporated by reference herein. The dyes or pigments may be in liquid form, or may be a powder dissolved into a solution, such as an aqueous solution, dispersed in a dispersion or as a component in an emulsion.

It should be noted that methods of applying the additive include, but are not limited to, dipping, immersing, submerging, soaking, rinsing, washing, painting, coating, showering, drizzling, spraying, placing, dusting, sprinkling, affixing, and any combination thereof. Further, it should be noted that the methods of applying include, but are not limited to, surface treatments, infusion treatments where the additive incorporates at least partially into the filament, and any combination thereof.

V. Tow Manufacturing

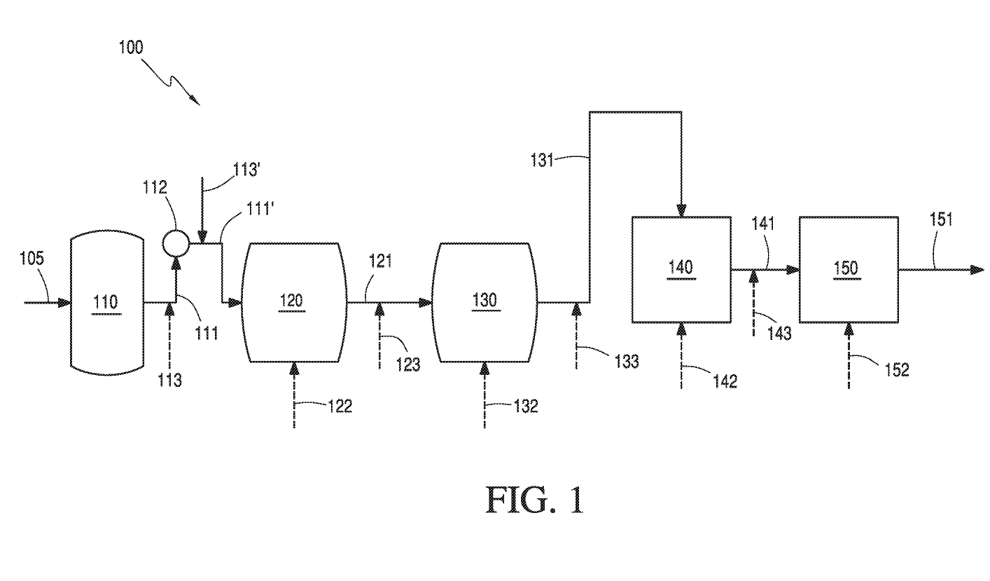

Once formed, filaments may be formed into a tow and then baled for ease of storage and shipment. FIG. 1 shows an exemplary tow process 100 that may be used for the forming the filaments described herein into tow. The initial material used to form the filaments, generally in the form of a dope, is fed to spinner 110 via line 105. Spinner 110 is operated at temperature suitable for the formation of filaments and removal of solvent. Although the initial material is generally wet spun, the material may also be melt spun or dry spun, depending on the desired production method. Regardless of the process for preparing and spinning the initial material, filaments are removed from spinner 110 via line 111. Filaments in line 111 are then directed to a roller 112 to bundle the filaments to form a tow 111′. Tow 111′ is then directed to crimper 120. Tow 111′ may be plasticized (not shown) prior to being passed to crimper 120. Crimped tow (also referred to as a tow band) is removed from crimper 120 via line 121 and is directed to dryer 130. Dried crimped tow is removed from dryer 130 via line 131 and is directed to a baling station comprising baler 140 and bale press 150. The dried crimped tow is fed to baler 140 where the tow is layered to form a towlayer. The towlayer is then directed to the bale press 150 via line 141 to press the bale to the desired size and compression. The tow bale may also be wrapped while in bale press 150. The tow bale is removed via line 151 for storage and/or shipment to the first purchaser.

During the steps shown in FIG. 1, there are numerous locations in the process where the filaments, tow, or bale may be marked with an identifying marking as described herein. Each of these locations is indicated with a dotted line. In one aspect, prior to formation of the filaments into tow, the filaments in line 111 may be marked at location 113. The marking may be applied as the filaments exit spinner 110 and are directed to roller 112. In another aspect, once the tow is formed on roller 112, the tow may be marked prior to entering crimper 120 at location 113′. Another option is to mark the tow in dryer 120, at location 122. In this aspect, it may be the crimping pattern itself that serve to provide an identifying marking, such as a pattern. In another aspect, the tow may be marked after it exits crimper 120 but before it enters dryer 130, at location 123. Such a marking location may be particularly advantageous if the marking is printed or stamped, because subsequent drying of the tow may also serve to dry the marking. Similarly, the tow may be marked in dryer 130 at location 132. Another option for marking the tow is after it exits dryer 130 but before it enters baler 140, at location 133. This option may be advantageous because the tow can still easily be repeatedly marked but is also close it is final form (i.e., no further drying occurs) and because the tow is moving more slowly by this point in the process. Similar advantages may also be realized by marking the tow in baler 140 at location 142. Depending on the number of repeated markings desired, and on the end use of the tow, the tow may also be marked at location 143, after the tow has been baled but prior to compression in bale press 150, or the tow may be marked at location 152, in bale press 150.

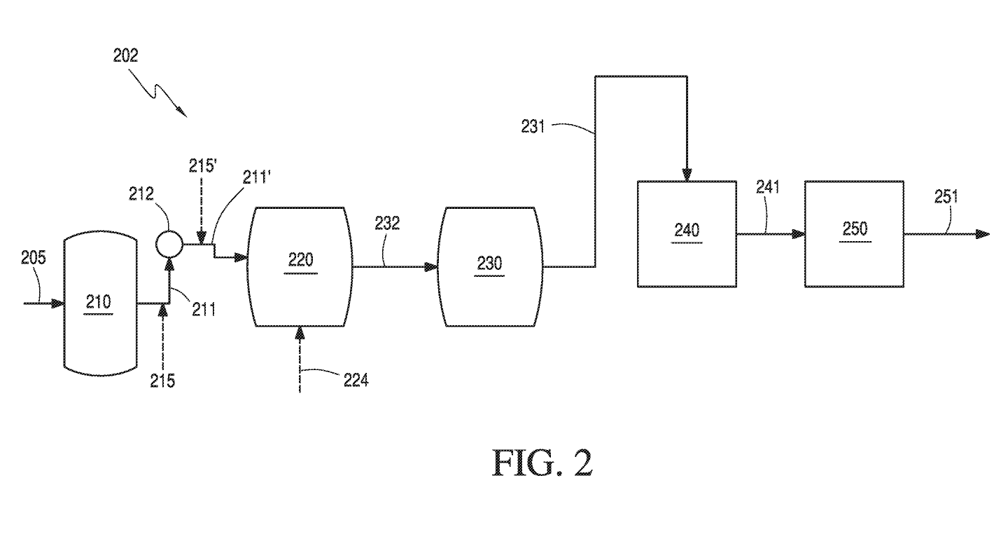

FIG. 2 shows an exemplary tow process 202, where the same basic steps for forming the tow and bale occur. In this figure, instead of showing locations for marking the tow or filament, locations for marking an additive are indicated. As described herein, an additive may be incorporated into the tow or textile. Although the additive may be added as far downstream in the process as baler 240, the additive is preferably added after the filaments exit spinner 210 but prior to exiting crimper 220. In one aspect, the additive is included in the filaments at location 215 prior to forming the filaments into tow on roller 212. In another aspect, the additive is included in the tow once it has been formed but prior to entering crimper 220, at location 215′. In a further aspect, the additive may be include during crimping, at location 224. In each of these embodiments, the additive may be marked as it is introduced into the filaments or tow at locations 215, 215′ or 224. Again, although additive may be included at the other locations indicated in FIG. 1, for uniformity of inclusion of the additive, earlier locations may be preferred.

It is also within the scope of this invention to include an additive that has been pre-marked. By including a pre-marked additive, the marking step does not occur in the tow process and thus the process is simplified. In this aspect, the marked additive may be incorporated into the filaments or tow at any of the locations specified in FIGS. 1 and 2.

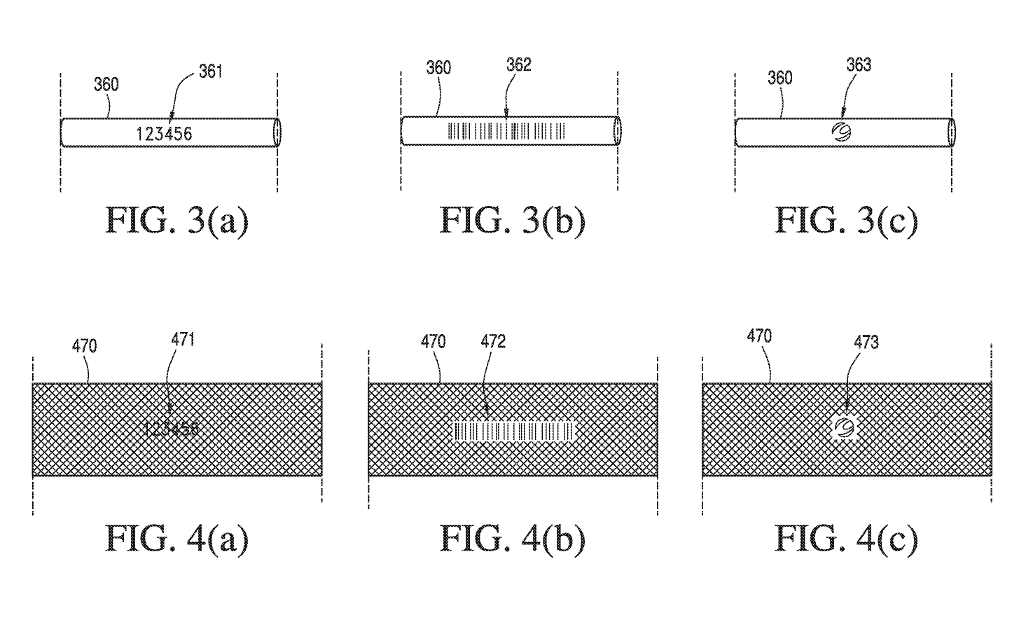

FIGS. 3(a) to (c) are illustrations of how a marking in accordance with the present invention would appear on a filament if an individual filament were marked. As shown, FIG. 3(a) indicates a number marking, FIG. 3(b) indicated a barcode marking, and FIG. 3(c) indicates an image marking. FIGS. 4(a) to (c) are illustrations of how a marking in accordance with the present invention would appear on tow if the tow were marked (as opposed to the individual filaments). As shown, FIG. 4(a) indicates a number marking, FIG. 4(b) indicated a barcode marking, and FIG. 4(c) indicates an image marking. In FIGS. 4(a) to (c), the marking is not readable on individual filaments, but is readable on the tow. In FIGS. 3(a) to (c), the marking is smaller in size but is readable on individual filaments, generally by a scanner or other device to aid the human eye.

VI. Tow Manufacture to End Product

The tow may be subjected to further processing to form an end product, such as a textile or a tobacco product. As described herein, it is important that the marking withstand the further processing so that it is still readable on the end product.

Tobacco Products

For tobacco products, once baled, the tow is generally shipped to a first purchaser where it is de-baled, bloomed, and formed into a cigarette filter. However, it is also within the scope of the present invention to have a single location manufacturing process, where the tow is formed into a towlayer and then bloomed, omitting the baling process. Each processing step is now described in more detail.

De-baling refers to withdrawing the tow from the bale in which it has been packaged. Depending on how the tow bales were crimped, compressed and packaged, as well as the downstream production needs, the tow de-baling may be at varied speeds. The tow may be de-baled by being withdrawn from the tow bale and drawn over guides by rollers. The tow is then opened or “bloomed,” formed into a rod, and then wrapped with paper, referred to as a plugwrap. The filter rod is then cut to a specified length and attached to a cigarette.

During the blooming process, the tow may be opened by using mechanical means, including a pneumatic banding jet, and stretched under tension or semi-tension techniques using rollers. In some aspects, instead of mechanical means, air may be used to separate the filaments. When mechanical means are used, the blooming process may remove a portion of the crimp. Accordingly, if crimping is used to impart the identifying marking onto the tow, the marking must be applied in such a way that it is still readable even if some of the crimp is removed.

The blooming process may comprise adding plasticizer to the tow and allowing the plasticized tow to cure. Addition of the plasticizers allows for softening of the fiber to enable inter-fiber bonds to form which then harden the filter to a desired hardness and consistency. In some aspects, the plasticizer is only applied to one side of the bloomed tow but should penetrate the tow. In other aspects, plasticizer may be applied to each side of the tow. The plasticizer may be any plasticizer used in the art, including the plasticizers disclosed in Section III.

Once the tow has been opened, a continuous supply of the tow is directed to an apparatus for forming a rod. One such apparatus is disclosed in U.S. Publication No. 2012/0302416, the entirety of which is incorporated by reference herein, but numerous apparatuses to manufacture cigarette rods are known in the art. Manufacturers of rod making machines include Molins PLC as well as Hauni-Werke Korber & Co. KG. The tow is formed into a cylindrical rod and wrapped with the plugwrap. The plugwrap may be adhered to the rod with an adhesive and the rod is then attached to the smokeable rod of the cigarette.

Textiles

When packaged in a bale, tow may similarly be de-baled and bloomed as described herein prior to forming the tow into textiles. Once the tow has been bloomed, additives may be incorporated into the tow, including superabsorbent polymers, glues, adhesives, fragrances, wood pulp, deodorizers, anti-microbial agents, flame retardants, pigments, dyes, and combinations thereof. Additional processing steps depend on the final textile end product. For example, E.P. Publication No. 1096047, the entirety of which is incorporated by reference herein, discloses processing steps for forming a diaper from tow. While diapers are one exemplary textile, the tow may be formed into any type of textile, including clothing, home good textiles for furniture, bedding and tablecloths, and outdoor fabrics, such as those used for outdoor cushions.

VII. Reading of the Marking

As described herein, the application of an identifying marking providing origin information of the product early in the production of the product, e.g., marking the filament and/or tow, allows for determination of where a breakdown in the supply chain occurred in the event of counterfeiting or diversion. For example, a shipment of clothing may be seized at a port of entry into a country because it is suspected of being counterfeit. Because of the marking of the current invention, a customs official can track and trace where the filaments forming the clothing were manufactured. Depending on the type of marking, the official may read the marking (either with the human eye unaided, or with a machine, such as a microscope, scanner, or activator). The official may then contact the manufacturer to let the manufacturer know that the shipment has been seized and the manufacturer may compare the identifying marking with inventory records. The manufacturer can then determine to whom the filament or tow was first sold, and can continue through the supply chain to determine if it was the first purchaser, or another purchaser who counterfeited a legitimate good. Similarly, if clothing is suspected of being diverted, the process could be carried out to determine a location of manufacture.

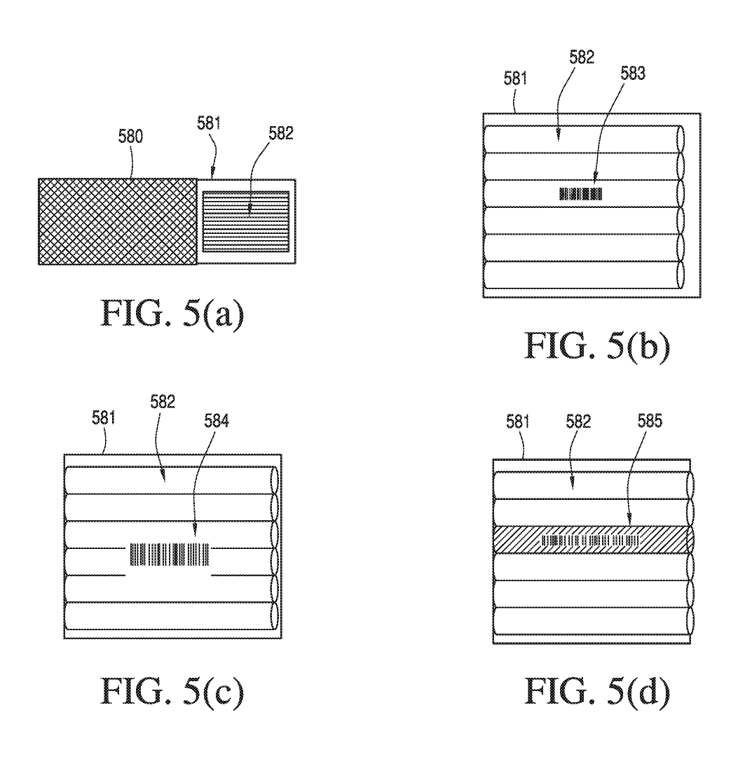

In the case of tobacco products, the customs official would be able to dissect the cigarette to expose the identifying marking in the cigarette filter, read the marking as described herein, and work with the manufacturer to determine where the breakdown in the supply chain occurred. FIG. 5(a) is an illustration of a cross-section of a dissected cigarette. Smokeable rod 580 and filter 581 have been cut in half to expose the inside of the cigarette. Filter 581 is a tow comprised of filaments 682. FIG. 5(b) illustrates an enlarged portion of tow 582, in which a filament in the tow is marked with barcode 583. The customs official may scan barcode 583 to determine the origin information for the filaments. FIG. 5(c) illustrates a larger barcode marking 584, which was applied to the tow and thus is not contained on a single filament. FIG. 5(d) illustrates that the tow comprises filaments 582 which are not marked and also comprises an additive, such as a filament 585, which is different than filaments 582, and which comprises a barcode marking. In an exemplary embodiment, filaments 582 may be comprised of cellulose acetate while additive filament 585 may be comprised of polypropylene.

The tracking and tracing need not even be limited to the end product, and may be used just for the filaments, tow, or an intermediate product, such as a fabric, rod or cigarette filter. Because each end product contains the marking, a pattern of counterfeiting or diverting can also be detected if numerous identifying markings are detected.

As described herein, the marking contains origin information. This origin information may be recorded at the time of manufacture of the filament, tow and/or tow bale. The recorded information may then be saved in a record, such as an inventory record, that can be cross-referenced by the manufacturer. The recording may be manual, e.g., by manual entry into a database or inventory list, or may be automated. The automated system may use a centralized management system which reads the marking, such as a barcode, and reads the origin information. The read origin information is then transmitted to a storage unit, such as a computer, where the information is stored. The information may be stored on the computer, as a hard copy, and/or may be stored on a server or on the cloud. An exemplary inventory tracking and management apparatus is disclosed in U.S. Pat. No. 5,962,834, the entire contents and disclosures of which are incorporated by reference herein.

In further aspects, the marking is applied at the time of manufacture but need not immediately be linked to the inventory record. Instead, the inventory record may be kept separately and should the marking be read and origin information requested, the inventory record may then be consulted. For example, when the marking is a number indicating the date of manufacture, the manufacturer may then use that date to compare to inventory records which track the supply chain for the specific filament, tow and/or tow bale manufactured. The manufacturer may also use the information to track where a breakdown in the process occurs. For example, if a manufacturer is notified of several different bales that have ended up being used in illicit trade, the manufacturer may compile this information and determine which purchasers have a repeated occurrence of ultimate diversion of the end product.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A method of making tow having an identifying marking, the method comprising:
(a) forming tow from filaments;
(b) crimping the tow;
(c) drying the tow;
(d) baling the tow; and
(e) incorporating an additive with an identifying marking during, between or after any of steps (a) to (c), wherein the identifying marking provides origin information concerning the tow.

2. The method of claim 1, wherein the additive to the tow is selected from the group consisting of: a filament, a multifilament, a fiber, a non-woven fabric, a woven fabric, a yarn, a staple fiber, a particle, and combinations thereof.

3. The method of claim 1, wherein the additive is marked during incorporation during, between or after any of steps (a) to (c).

4. The method of claim 1, wherein the additive is marked prior to incorporation into the filaments or the tow.

5. The method of claim 1, wherein step (e) comprises printing the identifying marking onto the additive.

6. The method of claim 5, wherein the printing is nanoprinting.

7. The method of claim 1, wherein step (e) comprises embossing or etching the identifying marking onto the additive.

8. The method of claim 1, wherein the identifying marking is a barcode, an image, or a pattern.

9. The method of claim 1, wherein the identifying marking comprises a number, a letter, or combination thereof.

10. A method of tracking cigarette filter tow, the method comprising the steps of:
(a) forming the tow from filaments comprising at least one of a cellulose ester, polypropylene, polyester, polyethylene and viscose;
(b) marking the filaments or the tow with a repeated identifying marking containing point of manufacture information;
(c) providing the tow to a first purchaser;
(d) forming the tow into a product; and
(e) reading the identifying marking in the product to determine origin information of the tow.

11. The method of claim 10, wherein the origin information comprises at least one of:
(a) tow manufacturer;
(b) tow manufacture date;
(c) tow manufacture location; and/or
(d) tow manufacture bale identifier.

12. The method of claim 10, wherein the identifying marking is applied by printing, etching, or embossing.

13. The method of claim 12, wherein the printing is nanoprinting.

14. The method of claim 10, wherein the identifying marking is a barcode, an image, or a pattern.

15. The method of claim 10, wherein the identifying marking comprises a number, a letter, or combination thereof.

16. A method of tracking cigarette filter tow, the method comprising the steps of:
(a) forming the tow from filaments comprising at least one of a cellulose ester, polypropylene, polyester, polyethylene and viscose;
(b) incorporating an additive comprising a repeated identifying marking containing origin information of the tow;
(c) providing the tow to a first purchaser
(d) forming the tow into a product; and
(e) reading the identifying marking in the product to determine origin information of the tow.

17. The method of claim 16, wherein the origin information comprises at least one of:
(a) tow manufacturer;
(b) tow manufacture date;
(c) tow manufacture location; and/or
(d) tow manufacture bale identifier.

18. The method of claim 16, wherein the identifying marking is applied by printing, etching, or embossing.

19. The method of claim 16, wherein the identifying marking is a barcode, an image, or a pattern.

20. The method of claim 16, wherein the identifying marking comprises a number, a letter, or combination thereof.
